(19) United States
(12) Patent Application Publication
(10) Pub. No.: US 2016/0026534 A1
(43) Pub. Date: Jan. 28, 2016

(54) METHOD AND DEVICE FOR SAVING STORAGE SPACE

(71) Applicant: Xiaomi Inc., Beijing (CN)

(72) Inventors: Yi Ru, Beijing (CN); Huadong Liu, Beijing (CN); Aljun Wang, Beijing (CN); Xianchao Shen, Beijing (CN); Jun Zhang, Beijing (CN)

(73) Assignee: Xiaomi Inc., Beijing (CN)

(21) Appl. No.: 14/610,335

(22) Filed: Jan. 30, 2015

Related U.S. Application Data
(63) Continuation of application No. PCT/CN2014/091617, filed on Nov. 19, 2014.

(30) Foreign Application Priority Data
Jul. 23, 2014 (CN) 201410353668.4

(51) Int. Cl. G06F 11/14; G06F 3/0481; H04L 29/08; G06F 9/445

(52) U.S. Cl. CPC G06F 11/1448; G06F 8/61; G06F 8/62; G06F 3/04817; H04L 67/34; G06F 2201/865

(57) ABSTRACT

A method and a device for saving storage space of a terminal device are provided. The method may include: determining an application to be backed up in applications installed locally; sending an installation package and data relating to the application determined to a server for back-up; and uninstalling locally the application and reserving an icon of the application. The terminal device may include: a determination module, a backup module and an uninstall module. The terminal device and method in the present disclosure may have the advantages of effectively saving storage space, avoiding the application from occupying storage space for a long time, and reducing waste of storage space.

### PRIORITY STATEMENT

This application is a Continuation Application of International Application No. PCT/CN2014/091617, filed on Nov. 19, 2014, based on and claims priority to Chinese Patent Application No. 201410353668.4, filed on Jul. 23, 2014, the entire of which are incorporated herein by reference.

### TECHNICAL FIELD

The present disclosure generally relates to a field of communication, and more particularly, to a method and a device for saving storage space in an intelligent communication device.

### BACKGROUND

Various applications are generally installed on an intelligent device. However, some applications are less frequently used, causing waste of storage space of the intelligent device.

### SUMMARY

The present disclosure relates to devices and methods that uninstall and back up not-frequently-used applications to save storage spaces in the device.

According to an aspect of the present disclosure, a terminal device may comprise a processor-readable storage medium comprising a set of instructions for saving storage space of the terminal device; and a processor in communication with the storage medium. When executing the set of instructions, the processor may be directed to: select a candidate application from a plurality of applications locally installed in the terminal device; send a recovering package associated with the candidate application to a server to back up; uninstall the candidate application from the terminal device; and store an icon associated with the candidate application after the candidate application is uninstalled. When the icon is clicked, the processor may download the recovering package from the server; recover the candidate application according to the recovering package; and activate the candidate application on the terminal device.

According to another aspect of the present disclosure, a method for saving storage space of a terminal device may comprise: selecting, by a terminal device, a candidate application from a plurality of applications locally installed in the terminal device; sending, by the terminal device, a recovering package associated with the candidate application to a server to back up; uninstalling, by the terminal device, the candidate application from the terminal device; and storing, by the terminal device, an icon associated with the candidate application after the candidate application is uninstalled. When the icon is clicked, the method may further comprise downloading, by the terminal device, the recovering package from the server; recovering, by the terminal device, the candidate application according to the recovering package; and activating, by the terminal device, the candidate application on the terminal device.

According to yet another aspect of the present disclosure, a processor-readable non-transitory storage medium may comprise a set of instructions for saving storage space of a terminal device. When being executed by a processor, the set of instructions directs the processor to perform acts of: selecting a candidate application from a plurality of applications locally installed in the terminal device; sending a recovering package associated with the candidate application to a server to back up; uninstalling the candidate application from the terminal device; and storing an icon associated with the candidate application after the candidate application is uninstalled, wherein a click operation on the icon serves as an instruction to reinstall and activate the candidate application. When the icon is clicked, the set of instructions further directs the processor to perform acts of downloading the recovering package from the server; recovering the candidate application according to the recovering package; and activating the candidate application on the terminal device.

It is to be understood that both the foregoing general description and the following detailed description are example and explanatory only and are not restrictive of the disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart showing a method for saving storage space according to an example embodiment.

FIG. 2 is a flow chart showing a method for saving storage space according to another example embodiment.

FIG. 3 is a flow chart showing a method for saving storage space according to another example embodiment.

FIG. 4 is a block diagram showing a device for saving storage space according to another example embodiment.

FIG. 5 is a block diagram showing a device for saving storage space according to another example embodiment.

FIG. 6 is a block diagram showing a device for saving storage space according to another example embodiment.

FIG. 7 is a block diagram showing a device for saving storage space according to another example embodiment.

FIG. 8 is a block diagram showing a device for saving storage space according to another example embodiment.

### DETAILED DESCRIPTION

Reference will now be made in detail to example embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the invention. Instead, they are merely examples of apparatuses and methods consistent with aspects related to the invention as recited in the appended claims.

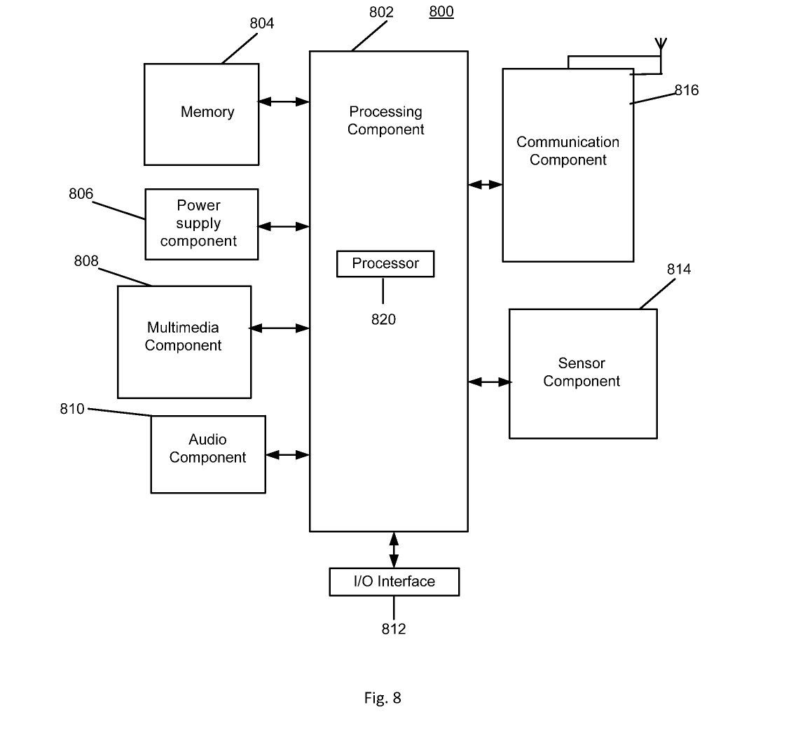

FIG. 8 is a block diagram showing a device 800 for saving storage space according to an example embodiment. For example, the device 800 may be a mobile telephone, a computer, a digital broadcasting terminal device, a message transceiver device, a games console, a tablet device, a medical device, a fitness facility, a PDA (personal digital assistant) and the like.

The device 800 may include one or a plurality of components as below: a processor component 802, a memory 804, a power supply component 806, a multimedia component 808, an audio component 810, an input/output (I/O) interface 812, a sensor component 814 and a communication component 816.

The processor component 802 usually controls the overall operation of the device 800, for example, display, telephone call, data communication, and operation associated with camera operation and record operation. The processor component 802 may include one or a plurality of processors 820 for executing instructions so as to complete operations of the above method in part or in whole. In addition, the processor component 802 may include one or a plurality of modules for the convenience of interaction between the processor component 802 and other components. For example, the processor component 802 may include a multimedia module for the convenience of interaction between the multimedia component 808 and the processor component 802.

The memory 804 is configured to store data of different types so as to support the operation of the device 800. Examples of the data include any application program or approach directive for operation of the device 800, including contact data, phonebook data, message, picture and video, etc. The memory 804 may be realized by volatile or non-volatile memory device of any type or combination thereof, for example, static random access memory (SRAM), electrically erasable programmable read-only memory (EEPROM), erasable programmable read only memory (EPROM), programmable read-only memory (PROM), read-only memory (ROM), magnetic memory, flash memory, magnetic disk or optical disk.

The memory 804 may store sets of instructions and/or computer logics implementing methods in the present disclosure. The processor 820 may communicate with the memory 804 to execute the sets of instructions and perform operations to complete the methods.

The power supply component 806 provides power for components of the device 800. The power supply component 806 may include a power management system, one or a plurality of power supplies, and other components associated with generation, management and power distribution of the device 800.

The multimedia component 808 includes a screen between the device 800 and a user and for providing an output interface. In some embodiments, the screen may include an LCD (Liquid Crystal Display) and a touch panel (TP). If the screen includes a touch panel, the screen may be realized as a touch screen for receiving input signal from users. The touch panel includes one or a plurality of touch sensors for sensing gestures on the touch panel, for example, touching and sliding, etc. The touch sensor not only can sense boundaries of a touching or sliding operation, but also can detect the duration and pressure related to the touching or sliding operation. In some embodiments, the multimedia component 808 includes a front-facing camera and/or a rear-facing camera. When the device 800 is under an operation mode, for example, capture mode or video mode, the front-facing camera and/or the rear-facing camera may receive external multimedia data. Each front-facing camera and rear-facing camera may be a fixed optical lens system or have focal length and optical zoom capacity.

The audio component 810 is configured to output and/or input audio signal. For example, the audio component 810 includes a microphone (MIC); when the device 800 is under an operation mode such as call mode, record mode and speech recognition mode, the microphone is configured to receive external audio signal. The audio signal received may be further stored in the memory 804 or sent out by the communication component 816. In some embodiments, the audio component 810 also includes a loudspeaker for outputting audio signal.

The I/O interface 812 provides interface for the processor component 802 and peripheral interface modules, the peripheral interface modules may be a keyboard, a click wheel and buttons, etc. These buttons may include but not limited to: home button, volume button, start button and locking button.

The sensor component 814 includes one or a plurality of sensors for providing the device 800 with state evaluation from all aspects. For example, the sensor component 814 may detect the on/off state of the device 800, relative positioning of components, for example, the components are the display and keypads of the device 800; the sensor component 814 also may detect the position change of the device 800 or a component thereof, the presence or absence of users' touch on the device 800, the direction or acceleration/deceleration of the device 800, and temperature variation of the device 800. The sensor component 814 may also include a proximity detector, which is configured to detect the presence of nearby objects in case of no physical touch. The sensor component 814 may also include an optical sensor, for example, CMOS or CCD image sensor for imaging. In some embodiments, the sensor component 814 may also include an acceleration sensor, a gyro sensor, a magnetic sensor, a pressure sensor, or a temperature sensor.

The communication component 816 is configured to facilitate wired communication or wireless communication between the device 800 and other equipment. The device 800 is available for access to wireless network based on communication standards, for example, WiFi, 2G or 3G, or combination thereof. In an example embodiment, the communication component 816 receives by means of a broadcast channel the broadcast signal or broadcast-related information from external broadcast management systems. In an example embodiment, the communication component 816 also includes a near field communication (NFC) module for promoting short-range communication. For example, the NFC module may be realized on the basis of Radio Frequency Identification (RFID) Technology, Infrared Data Association (IrDA) Technology, Ultra-wide Bandwidth (UWB) Technology, Bluetooth (BT) Technology and other technologies.

In example embodiments, the device 800 may be realized by one or a plurality of application specific integrated circuits (ASIC), digital signal processors (DSP), digital signal processing equipment (DSPD), programmable logic devices (PLD), field programmable gate arrays (FPGA), controllers, microcontrollers, microprocessors or other electronic components, configured to execute the above methods.

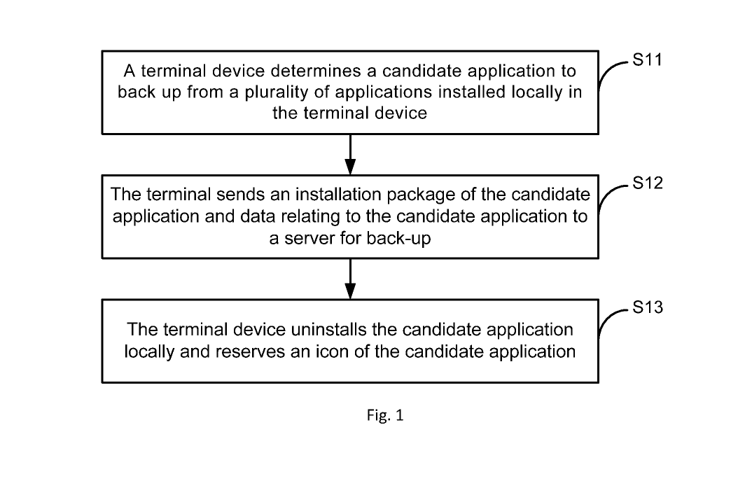

FIG. 1 is a flow chart showing a method for saving storage space according to an example embodiment. The method may be implemented in a terminal device such as the device 800. The terminal device may be a terminal device of any type, including but not limited: a computer, a laptop, a mobile phone, a tablet computer and the like. A plurality of applications may be installed in the terminal device, and the determined application to be backed up may be one application or a plurality of applications, not limited herein. The method may comprise the following operations:

In Operation S11, the terminal device determines and/or selects a candidate application to uninstall and back up from a plurality of applications installed locally in the terminal device.

The terminal device may monitor the usage activity of the plurality of applications local installed on the terminal device during the daily use of these applications, and then select the candidate application based on predetermined activity parameters associated with the candidate application. For example, the predetermined parameters may be user selection or an activation status thereof, such as an activation frequency and/or a period of deactivation time of the candidate application. For example, a user of the terminal device may select an application from the plurality of locally installed applications as the candidate application to uninstall and back-up. For example, the terminal device may determine a frequency that an application is used and run (i.e., an activation frequency) on the terminal device. If the application has not been activated (i.e., used) over a predetermined frequency (e.g., if the application in average was not used once a week), the terminal device may select the application as the candidate application to be uninstalled and backed up. In another example, the terminal device may also determine the candidate application based on a period of time that an application has been deactivated. For example, if an application has not been used (i.e., not run by the terminal device) over a predetermined period of time (e.g., a month), the terminal device may select the application as the candidate application. Further, the terminal device may combine the deactivation period and activation frequency in selecting a candidate application. For example, the terminal device may only select those local applications that have not been activated over a month and the average activation frequencies are lower than one time per week as candidate applications.

In Operation S12, the terminal sends an installation package of the candidate application and data relating to the candidate application to a server for back-up.

Wherein, the installation package of the application is used to install the candidate application, and the data relating to the candidate application may be recovering data of the candidate application, so that the recovering data may recover the reinstalled candidate application into the same status that the candidate application has been when the candidate application was uninstalled. For example, the recovering data may include usage record of the candidate application, such as historical operation data generated by the candidate application during the time that the candidate application ran on the terminal device. For example, the recovering data may include personal information of a user of the candidate application, status information of the candidate application and the terminal device, progress information of the candidate application and the like saved by the user, to which the embodiment makes no concrete restriction.

The server may be a computer server remotely connected to the terminal device over a network. For example, the server may be a server in the cloud. The server may have a structure similar to the device 800 or any computer server commercially available.

In Operation S13, the terminal device uninstalls the candidate application locally and reserves and/or stores an icon of the candidate application, wherein a click operation on the icon servers as an instruction to activate the candidate application.

The icon may be reserved in the original place where it was. For example, when the icon was initially on the desktop of the terminal device, the icon may remain on the desktop when the candidate application is uninstalled. The icon may also be moved to a place specially created for the candidate application. For example, the terminal device may create a folder for all application that is locally uninstalled in similar way with back-up installation packages stored in the server. Further, the terminal device may modify an appearance of the icon so that a user of the terminal device may recognize from the appearance that the candidate application is locally uninstalled and backed up in the server. For example, if initially the icon is colorful, the terminal device may change the icon to gray after the uninstallation.

Wherein, storage space of the application in a terminal device may be saved by uninstalling the application, and waste of storage space may be effectively avoided. Users will not be confused because they do not perceive that the application has been uninstalled as an icon of the application uninstalled is reserved on the desktop, which is more in line with users' usage habits.

The method may also comprise:

The terminal device downloads the installation package and data of the candidate application from the server when the icon preserved in the candidate application is activated (e.g., when a user clicks on the icon);

The terminal device recovers the candidate application by reinstall the installation package and recovers the saved data of the candidate application, and then activates the application.

In the embodiment, determination of the candidate application from the plurality of local applications comprises at least one of followings:

From the plurality of locally installed applications, the terminal device determines and/or selects an application that is unused within the predetermined period of time as the candidate application;

From the plurality of locally installed applications, the terminal device determines and/or selects an application used below the predetermined frequency within a predetermined period as the candidate application; and

From the plurality of locally installed applications, the terminal device determines and/or selects an application expressly selected by the user as the candidate application.

In the embodiment, the sending of the installation package and data relating to the candidate application to the server for back-up may comprise:

The terminal device may query the server whether the application has been backed up when it was initially installed in the terminal device or after the candidate application was installed;

When the server confirms that the candidate application was not backed up, the terminal sends the installation package of the candidate application and the data relating to the usage of the candidate application to the server. When the server confirms that the candidate application was indeed backed up, the terminal device may only update the data relating to the candidate application to the server.

In the embodiment, the historical operation data may comprise: data relating to the application as being stored in a memory; or the data may comprise: data relating to the application as being stored in a memory and in a cache.

The method according to the embodiment is characterized by: determining an application to be backed up in applications installed locally; sending an installation package and data relating to the application determined to a server for back-up; uninstalling locally the application and reserving an icon of the application, thus effectively saving storage space, avoiding the application from occupying storage space for a long time, and reducing waste of storage space.

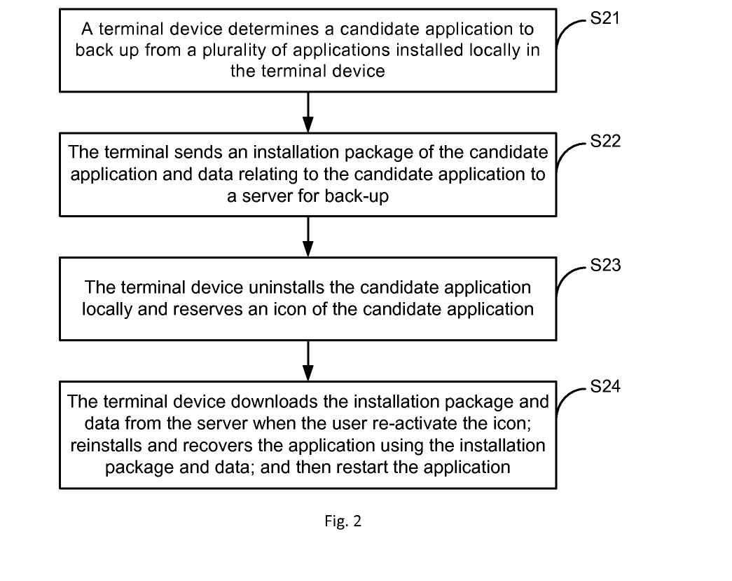

FIG. 2 is a flow chart showing a method for saving storage space according to another example embodiment. The method may be implemented in a terminal device such as the device 800. The terminal device may be a terminal device of any type, including but not limited: a computer, a laptop, a mobile phone, a tablet computer and the like. A plurality of applications may be installed in the terminal device, and the determined application to be backed up may be one application or a plurality of applications, not limited herein. The method may comprise the following operations:

In Operation S21, the terminal device determines and/or selects a candidate application to uninstall and back up from a plurality of applications installed locally in the terminal device.

The terminal device may monitor the usage activity of the plurality of applications local installed on the terminal device during the daily use of these applications, and then select the candidate application based on predetermined activity parameters associated with the candidate application. For example, the predetermined parameters may be user selection or an activation status thereof, such as an activation frequency and/or a period of deactivation time of the candidate application. For example, a user of the terminal device may select an application from the plurality of locally installed applications as the candidate application to uninstall and back-up. For example, the terminal device may determine a frequency that an application is used and run (i.e., an activation frequency) on the terminal device. If the application has not been activated (i.e., used) over a predetermined frequency (e.g., if the application in average was not used once a week), the terminal device may select the application as the candidate application to be uninstalled and backed up. In another example, the terminal device may also determine the candidate application based on a period of time that an application has been deactivated. For example, if an application has not been used (i.e., not run by the terminal device) over a predetermined period of time (e.g., a month), the terminal device may select the application as the candidate application. Further, the terminal device may combine the deactivation period and activation frequency in selecting a candidate application. For example, the terminal device may only select those local applications that have not been activated over a month and the average activation frequencies are lower than one time per week as candidate applications.

In Operation S22, the terminal sends an installation package of the candidate application and data relating to the candidate application to a server for back-up.

The installation package of the application is used to install the candidate application, and the data may be recovering data of the candidate application, so that the recovering data may recover the reinstalled candidate application into the same status that the candidate application has been when the candidate application was uninstalled. For example, the recovering data may be usage record of the candidate application, such as historical operation data generated by the candidate application during the time that the candidate application ran on the terminal device. For example, the recovering data or usage record may also include personal information of a user of the candidate application, status information of the candidate application and the terminal device, progress information of the candidate application and the like saved by the user, to which the embodiment makes no concrete restriction.

The data may comprise data relating to the candidate application as being stored in a memory; or data relating to the candidate application as being stored in a memory and in a cache.

Wherein, the usage record may include usage information and/or temporary information saved by the user when using the candidate application, and the temporary information may be backed up in the server so that the information may be retrieved in recovery installation of the candidate application, thus ensuring that the candidate application after recovery installation stays the same as it was before the uninstallation.

When uninstalling the candidate application, the terminal device may further query in the server whether the application has been backed up when it was initially installed in the terminal device or after the candidate application was installed;

When the server confirms that the candidate application was not backed up, the terminal sends the installation package of the candidate application and the historical operation data relating to the usage of the candidate application to the server. When the server confirms that the candidate application was indeed backed up, the terminal device may only update the data relating to the candidate application to the server.

In Operation S23, the terminal device uninstalls the candidate application locally and reserves and/or stores an icon of the candidate application, wherein a click operation on the icon servers as an instruction to activate the candidate application.

The icon may be reserved in the original place where it was. For example, when the icon was initially on the desktop of the terminal device, the icon may remain on the desktop when the candidate application is uninstalled. The icon may also be moved to a place specially created for the candidate application. For example, the terminal device may create a folder for all application that is locally uninstalled in similar way with back-up installation packages stored in the server. Further, the terminal device may modify an appearance of the icon so that a user of the terminal device may recognize from the appearance that the candidate application is locally uninstalled and backed up in the server. For example, if initially the icon is colorful, the terminal device may change the icon to gray after the uninstallation.

In Operation S24, the terminal device downloads the installation package and data from the server when the user re-activate the preserved icon (e.g., when the user clicks the preserved icon); reinstalls and recovers the application using the installation package and data; and then restart and/or initiated the application.

In the embodiment, the reserved icon of the uninstalled candidate application not only is a shortcut of the application, but also is a start button for reinstalling the application. The installation is triggered and the application is initiated after the user clicks on the icon. Wherein, the installation of the candidate application is completed by fast downloading the backup installation package and data relating to the candidate application from the server and the candidate application is immediately started after completion of the installation. In this way, the user may not perceive the installation process of the candidate application. He/she may just feel like starting the candidate application, thus avoiding disturbing users, effectively reducing negative effect on users and greatly improving user experience.

The method according to the embodiment is characterized by: determining an application to be backed up in applications installed locally; sending an installation package and data relating to the application determined to a server for back-up; uninstalling locally the application and reserving an icon of the application, thus effectively saving storage space, avoiding the application from occupying storage space for a long time, and reducing waste of storage space.

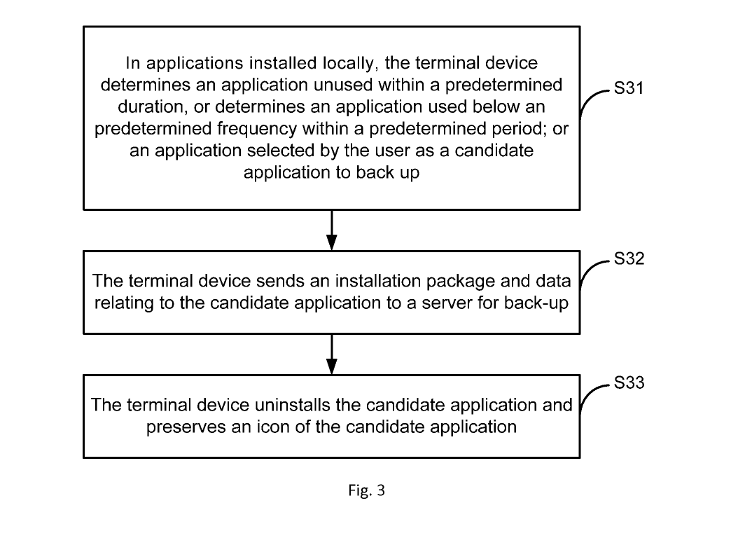

FIG. 3 is a flow chart showing a method for saving storage space according to another example embodiment, as shown in FIG. 3, the method is for use in a terminal device, comprising following operations:

In Operation S31, in applications installed locally, the terminal device determines and/or selects an application unused within a predetermined duration as a candidate application to be backed up, or determines and/or selects an application used below an predetermined frequency within a predetermined period as the candidate application to be backed up; or an application selected by the user as the candidate application to back up.

Wherein, the predetermined duration, the predetermined period and the predetermined frequency may be set according to the need, to which the embodiment makes no concrete restriction.

The application unused within a predetermined duration may refer to an application not used for a long time, which may be backed up and uninstalled, thus saving storage space, and not causing an impact on users. For example, an application not used within eight days, ten days, one month or three months may be treated as an application not used for a long time.

The application used below a predetermined frequency within a predetermined period may refer to an application with a lower frequency of utilization, which may also be backed up and uninstalled, thus saving storage space, and not causing an impact on users. For example, an application used below three times within two months, or an application used below six times within half a year, etc.

An application to be backed up which is determined in the above two scenes is determined in the background by the terminal device automatically, beyond the perception of the user. In another scene, the user may take the initiative to determine and/or select a candidate application to be backed up. Wherein, an application list is provided to the user. And the user may select corresponding applications for back-up according to the need. In this way, applications selected by the user may be backed up and uninstalled, thus reaching the effect of effectively saving storage space.

In Operation S32, the terminal device sends an installation package and data relating to the candidate application to a server for back-up.

In the embodiment, The terminal device may query the server whether the application has been backed up when it was initially installed in the terminal device or after the candidate application was installed;

When the server confirms that the candidate application was not backed up, the terminal sends the installation package of the candidate application and the historical operation data relating to the usage of the candidate application to the server. When the server confirms that the candidate application was indeed backed up, the terminal device may only update the data relating to the candidate application to the server.

Wherein, when the candidate application is installed for the first time, the terminal device may back up the installation package and data relating to the application in the server. Before the candidate application is backed up, the terminal device may query in the server whether the candidate application has been backed up or not. It is unnecessary to back up the installation package if the application has been backed up, thus improving the transmission efficiency. Under the circumstances, only data relating to the application needs backing up in the server. If the candidate application has not been backed up yet, both the installation package and data relating to the application shall be sent to the server for back-up.

In Operation S33, the terminal device uninstalls the candidate application and preserves an icon of the candidate application.

The icon may be reserved in the original place where it was. For example, when the icon was initially on the desktop of the terminal device, the icon may remain on the desktop when the candidate application is uninstalled. The icon may also be moved to a place specially created for the candidate application. For example, the terminal device may create a folder for all application that is locally uninstalled in similar way with back-up installation packages stored in the server. Further, the terminal device may modify an appearance of the icon so that a user of the terminal device may recognize from the appearance that the candidate application is locally uninstalled and backed up in the server. For example, if initially the icon is colorful, the terminal device may change the icon to gray after the uninstallation.

In the embodiment, the foregoing method may also comprise:

The terminal device downloads the installation package and data from the server when the icon preserved is clicked on; recover the installation of the application by using the installation package and data, and initiating the application.

In the embodiment, the data may comprise: data relating to the application as being stored in a memory; or data relating to the application as being stored in a memory and in a cache.

The method according to the embodiment is characterized by: determining an application to be backed up in applications installed locally; sending an installation package and data relating to the application determined to a server for back-up; uninstalling locally the application and reserving an icon of the application, thus effectively saving storage space, avoiding the application from occupying storage space for a long time, and reducing waste of storage space.

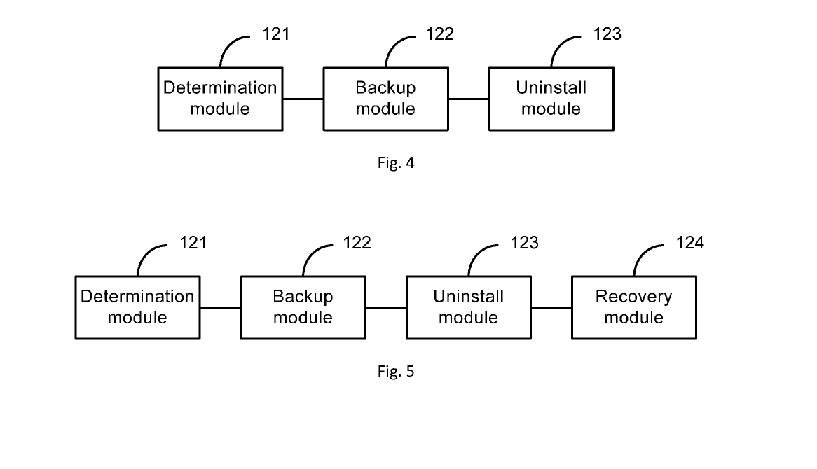

FIG. 4 is a block diagram showing a device for saving storage space according to another example embodiment. The device may be the device 800. Further, the device may be logically programmed or designed through hard ware to include: a determination module 121, a backup module 122 and an uninstall module 123.

The determination module 121 is configured to determine a candidate application to uninstall and back up in applications installed locally.

The backup module 122 is configured to send an installation package and data relating to the candidate application to a server for back-up.

The uninstall module 123 is configured to uninstall locally the candidate application and reserve an icon of the candidate application.

FIG. 5 is a block diagram showing a device for saving storage space according to another example embodiment. The device may be the device 800. In addition to the modules of FIG. 4, the device in FIG. 5 may further be logically programmed or designed through hard ware to include:

A recovery module 124, configured to download the installation package and data from the server when the icon preserved is clicked on; the installation of the candidate application is recovered by using the installation package and data, and the application is initiated.

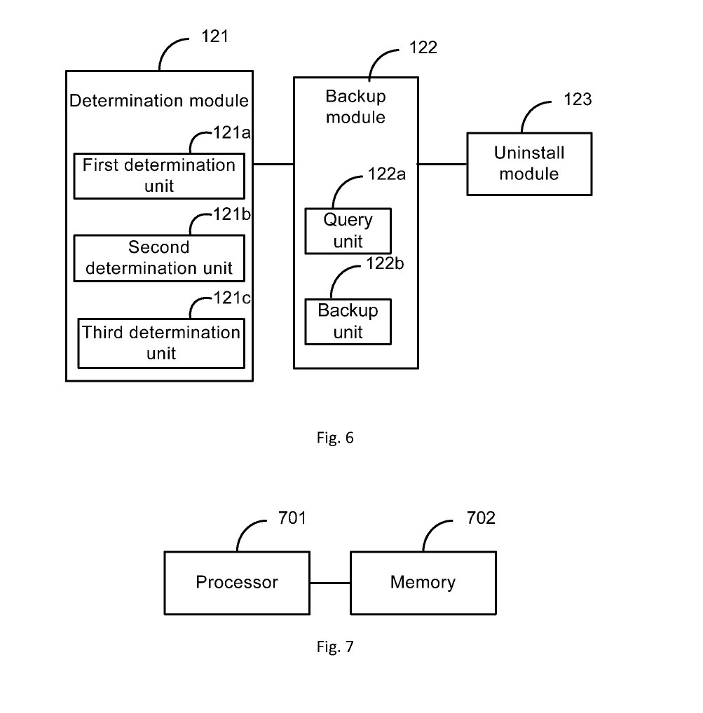

FIG. 6 is a block diagram showing a device for saving storage space according to another example embodiment. The device may be the device 800. In addition to the modules of FIG. 4, the determination module 121 may comprise at least one of:

A first determination unit 121a, configured to determine, in applications installed locally, an application unused within a predetermined duration as the candidate application to be backed up;

A second determination unit 121b, configured to determine, in applications installed locally, an application used below an predetermined frequency within a predetermined period as the candidate application to be backed up; and

A third determination unit 121c, configured to determine, in applications installed locally, an application selected by the user as the candidate application to be backed up.

The backup module 122 may comprise:

A query unit 122a, configured to query in the server whether the candidate application has been backed up during installation or use; and

A backup unit 122b, configured to send an installation package and data relating to the application to a server for back-up if it is confirmed by the server that the candidate application has not been backed up during installation.

Wherein, the data may comprise: data relating to the application as being stored in a memory; or data relating to the application as being stored in a memory and in a cache.

With regard to the device in the above embodiment, detailed description of specific manner for conducting operation of modules has been made in the embodiment related to the method, no detailed illustration will be made herein.

The device according to the embodiment is characterized by: determining an application to be backed up in applications installed locally; sending an installation package and data relating to the application determined to a server for back-up; uninstalling locally the application and reserving an icon of the application, thus effectively saving storage space, avoiding the application from occupying storage space for a long time, and reducing waste of storage space.

FIG. 7 is a block diagram showing a device for saving storage space according to another example embodiment. Referring to FIG. 7, the device may comprise:

A processor 701 and a memory 702 configured to store instructions executable by the processor; wherein, the processor 701 may be configured to: determine a candidate application to be backed up in applications installed locally; send an installation package and data relating to the candidate application to a server for back-up; and uninstall locally the candidate application and reserve an icon of the candidate application.

Referring back to FIG. 8, in example embodiments, the device 800 may include a non-transitory computer-readable storage medium, such as the memory 804 which includes a set of instructions implementing the methods and/or operations set forth above. The set of instructions may be executed by the processors 820 of the device 800 so as to achieve the above methods. For example, the non-transitory computer-readable storage medium may be ROM, random access memory (RAM), CD-ROM, magnetic tape, floppy disk and optical data storage device, etc.

When instructions in the storage medium are executed by the processor of a mobile terminal device, the mobile terminal device may execute a method for saving storage space, and the method may comprise: determining a candidate application to be backed up in applications installed locally; sending an installation package and data relating to the candidate application determined to a server for back-up; uninstalling locally the candidate application and reserving an icon of the application.

The method may also comprise: downloading the installation package and data from the server when the icon preserved is clicked on; recovering the installation of the candidate application by using the installation package and data, and initiating the candidate application.

Wherein, the determining of the candidate application may comprise at least one of followings: in applications installed locally, determining an application unused within a predetermined duration as the candidate application to be backed up; in applications installed locally, determining an application used below an predetermined frequency within a predetermined period as the candidate application to be backed up; and in applications installed locally, determining an application selected by the user as the candidate application to be backed up.

Wherein, the sending of the installation package and data relating to the application to the server may comprise: querying in the server whether the candidate application has been backed up during installation; sending an installation package and data relating to the candidate application to a server for back-up if it is confirmed from the server that the application has not been backed up during installation.

Wherein the data may comprise: data relating to the candidate application as being stored in a memory; or data relating to the candidate application as being stored in a memory and in a cache.

The non-transitory computer-readable storage medium according to the embodiment is characterized by: determining an application to be backed up in applications installed locally; sending an installation package and data relating to the application determined to a server for back-up; uninstalling locally the application and reserving an icon of the application, thus effectively saving storage space, avoiding the application from occupying storage space for a long time, and reducing waste of storage space.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as example only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

1. A terminal device, comprising:
a processor-readable storage medium comprising a set of instructions for saving storage space of the terminal device; and
a processor in communication with the storage medium, wherein when executing the set of instructions, the processor is directed to:
monitor predetermined activity parameters associated with usage activities of a plurality of applications local installed on the terminal device;
select, from the plurality of applications, a candidate application based on the predetermined activity parameters associated with the candidate application;
send a recovering package associated with the candidate application to a server to back up;
uninstall the candidate application from the terminal device; and
store an icon associated with the candidate application after the candidate application is uninstalled.

2. The terminal device of claim 1, wherein a click operation on the icon serves as an instruction to reinstall and activate the candidate application.

3. The terminal device of claim 1, wherein when receiving an instruction to activate the candidate application, the processor is further directed to:
download the recovering package from the server;
recover the candidate application according to the recovering package; and
activate the candidate application on the terminal device.

4. The terminal device of claim 3, wherein the recovering package comprises:
an installation package associated with the candidate application; and
a usage record of the candidate application.

5. The terminal device of claim 4, wherein the usage record comprises at least one of,
historical operation data generated by the candidate application during the time that the candidate application ran on the terminal device;
personal information of a user of the candidate application;
status information of the candidate application and the terminal device; and
progress information of the candidate application;

6. The terminal device of claim 4, wherein to send the recovering package to the server, the processor is further directed to:
query the server whether the installation package has been backed up;
send the installation package and the user record to the server to back up when the installation package has not been backed up;
send the usage record to the server to back up when the installation package has been backed up.

7. The terminal device of claim 1, wherein the predetermined activity parameters associated with the candidate application comprises:
an inactivation duration of the candidate application;
an activation frequency within a predetermined period of time; and
a selection from a user of the terminal device.

8. A method for saving storage space of a terminal device, comprising:
monitoring, by a terminal device, predetermined activity parameters associated with usage activities of a plurality of applications local installed on the terminal device;
selecting, by the terminal device from the plurality of applications, a candidate application based on the predetermined activity parameters associated with the candidate application;
sending, by the terminal device, a recovering package associated with the candidate application to a server to back up;
uninstalling, by the terminal device, the candidate application from the terminal device; and
storing, by the terminal device, an icon associated with the candidate application after the candidate application is uninstalled.

9. The method of claim 8, wherein a click operation on the icon serves as an instruction to reinstall and activate the candidate application.

10. The method of claim 8, further comprising, when receiving an instruction to activate the candidate application:
downloading, by the terminal device, the recovering package from the server;
recovering, by the terminal device, the candidate application according to the recovering package; and
activating, by the terminal device, the candidate application on the terminal device.

11. The method of claim 10, wherein the recovering package comprises:
an installation package associated with the candidate application; and
a usage record of the candidate application.

12. The method of claim 11, wherein the usage record comprises at least one of, historical operation data generated by the candidate application during the time that the candidate application ran on the terminal device;
personal information of a user of the candidate application;
status information of the candidate application and the terminal device; and
progress information of the candidate application;

13. The method of claim 11, wherein the sending of the recovering package to the server comprises:
querying the server whether the installation package has been backed up;
sending the installation package and the usage record to the server to back up when the installation package has not been backed up;
sending the usage record to the server to back up when the installation package has been backed up.

14. The method of claim 8, wherein the predetermined activity parameters associated with the candidate application comprises:
an inactivation duration of the candidate application;
an activation frequency within a predetermined period of time; and
a selection from a user of the terminal device.

15. A processor-readable non-transitory storage medium, comprising a set of instructions for saving storage space of a terminal device, wherein when being executed by a processor, the set of instructions directs the processor to perform acts of:
monitoring predetermined activity parameters associated with usage activities of a plurality of applications local installed on the terminal device;
selecting from the plurality of applications a candidate application based on the predetermined activity parameters associated with the candidate application;
selecting a candidate application from a plurality of applications locally installed in the terminal device;
sending a recovering package associated with the candidate application to a server to back up;
uninstalling the candidate application from the terminal device; and
storing an icon associated with the candidate application after the candidate application is uninstalled,
wherein a click operation on the icon serves as an instruction to reinstall and activate the candidate application.

16. The storage medium of claim 16, wherein when the icon is clicked, the set of instructions further directs the processor to perform acts of:
downloading the recovering package from the server;
recovering the candidate application according to the recovering package; and
activating the candidate application on the terminal device.

17. The storage medium of claim 3, wherein the recovering package comprises:
an installation package associated with the candidate application; and
a usage record of the candidate application.

18. The storage medium of claim 17, wherein the usage record comprises at least one of,
historical operation data generated by the candidate application during the time that the candidate application ran on the terminal device;
personal information of a user of the candidate application;
status information of the candidate application and the terminal device; and
progress information of the candidate application;

19. The storage medium of claim 17, wherein the sending of the recovering package to the server comprises:
querying the server whether the installation package has been backed up;
sending the installation package and the usage record to the server to back up when the installation package has not been backed up;
sending the usage record to the server to back up when the installation package has been backed up.

20. The storage medium of claim 15, wherein the predetermined activity parameters associated with the candidate application comprises:
an inactivation duration of the candidate application;
an activation frequency within a predetermined period of time; and
a selection from a user of the terminal device.
